(19) United States
(12) Patent Application Publication
(10) Pub. No.: US 2018/0275697 A1
(43) Pub. Date: Sep. 27, 2018

(54) Method For Controlling A Conditioning Unit And Consumption Measuring Device Having Such A Conditioning Unit

(71) Applicant: AVL LIST GmbH, Graz (AT)

(72) Inventors: Georg Lichtenegger, Graz (AT); Vedran Burazer, Graz (AT); Michael Buchner, Graz (AT); Ou Jun Zhou, Graz (AT)

(21) Appl. No.: 15/739,506

(22) PCT Filed: Jun. 9, 2016
(86) PCT No.: PCT/EP2016/063122

§ 371 Date: Dec. 22, 2017

(30) Foreign Application Priority Data
Jun. 23, 2015 (AT) A50530/2015

(51) Int. Cl. G05D 23/19; F02D 33/00; G01F 1/50

(52) U.S. Cl. CPC G05D 23/1923; G05D 23/1917; G01F 15/04; G01F 1/50; F02D 33/003

(57) ABSTRACT

The invention relates to a conditioning unit (3) comprising a base body (20) and a buffer storage (21), wherein a medium is supplied through the base body (20) and a temperature control unit (23) having a first heating surface (24) and a second heating surface (25) is arranged between the buffer storage (21) and the base body (20), and wherein a temperature spread is set between the first heating surface (24) and the second heating surface (25) by means of the temperature control unit (23). In order for the temperature of a gaseous or liquid medium to be exactly set and kept constant in spite of strong flow rate and pressure oscillations of the medium, the conditioning unit (3) is operated in a control to maintain a predetermined setpoint temperature (Tₛₒₗₗ) of the medium, wherein a control variable (Y) for the control of the conditioning unit (3) is composed of a model part (A), which calculates the power (Pᵥ) required for the temperature control of the medium in the conditioning unit (3), and a control part (R), which corrects the power (Pv) calculated by means of the model part (A), wherein a control error (F) based on the setpoint temperature (Tₛₒₗₗ) and an actual temperature (Tᵢₛₜ) is introduced in an exponential form into the control part (R).

### TECHNICAL FIELD

The present invention refers to a method for controlling a conditioning unit comprising a base body and a buffer storage, wherein a medium is supplied through the base body, and between the buffer storage and the base body a temperature control unit with a first heating surface and a second heating surface is arranged, and by means of the temperature control unit a temperature spread is set between the first and the second heating surface, as well as to the use of this method in a consumption measuring device for measuring the consumption of a gaseous medium. The invention also refers to a consumption measuring device for measuring the consumption of a gaseous medium, with an inlet connection, at which the gaseous medium is supplied to the consumption measuring device, and an outlet connection, at which the gaseous medium is provided from the consumption measuring device, wherein between the inlet connection and the outlet connection a gas path is provided, in which a consumption sensor is arranged and before the consumption sensor a conditioning unit is positioned for controlling the temperature of the gaseous medium and between the conditioning unit and the consumption sensor a pressure control unit is arranged, in which the gaseous medium is expanded.

### BACKGROUND

In order to exactly measure the fuel consumption of a combustion engine on a test bed, a precise conditioning of the temperature and pressure of the fuel supplied to the combustion engine is required. The measuring of the fuel consumption often occurs by means of a known Coriolis flow sensor. To do so, a pre-circuit and a measuring circuit are formed for the liquid fuel, in which liquid fuel is circulated. The flow sensor is disposed between the pre-circuit and the measuring circuit. The measuring circuit is closed via the combustion engine to which the fuel is to be supplied to. The purging quantity usual in liquid fuel supplying systems is thus fed back into the measuring circuit. The pre-circuit is used to provide the measuring circuit with the fuel quantity burnt in the combustion engine. The interposed flow sensor thus measures exactly the consumed amount of liquid fuel. Since liquid fuel has a considerable thermal expansion coefficient, the temperature in the measuring circuit has to be kept as constant as possible, in order to prevent possible measuring errors due to volume variations due to temperature oscillations of the fuel in the measuring circuit. Since the purge quantity fed back into the measuring circuit is heated by the fuel supply system of the combustion engine, it is required to control the temperature of the fuel in the inlet to the combustion engine. Also in the pre-circuit, in order to obtain precise consumption measurements, volume variations due to temperature oscillations have to be prevented. Thus, the fuel in the pre-circuit is also temperature-controlled. Moreover, the pressure of the liquid fuel which is supplied to the combustion engine is kept as much as possible at a constant level by means of pressure regulation units. Additionally, both the temperature and the pressure of the fuel depend on the actual flow. Examples of such a measurement of the fuel consumption are provided in US 2014/0123742 A1 and EP 1 729 100 A1, which pertain to the conditioning of liquid fuels. Therein, the temperature of the fuel is adjusted by means of a heat exchanger with a cooling liquid. However, such a heat exchanger is slow and only allows slow temperature variations, which is however sufficient for liquid fuels, since the temperature has only to be kept as constant as possible. Besides that, such a heat exchanger requires additional components and controls for operating the heat exchanger, which also renders the system more costly.

The above-described systems for measuring the fuel consumption of a combustion engine may basically be used also for gaseous fuels, for instance for a gas engine.

However, such a system is unfavorable in case of gaseous fuels, since corresponding compressors or fans would be required for circulating the gaseous fuel in the pre-circuit and measuring circuit, which would considerably increase the cost and size of such a system. Apart of this, a compressor would again massively influence the temperature of the gaseous medium, which is counterproductive with respect to the required temperature regulation.

In case of gaseous fuels, such as natural gas or hydrogen, the additional problem arises that the gaseous fuel is usually present or supplied under high pressure and thus has to be previously expanded to a requested lower pressure in order to be used as a fuel in a combustion engine (in this case a gas engine). During expansion of the gaseous fuel, however, the fuel may experience a strong cooling (Joule-Thomson effect), which may be problematic for subsequent components of the conditioning system, for instance due to the formation of condensate and ice in the gas pipes or other components in the gas lines. Thus, the gaseous fuel is usually heated prior to expansion, so that by expansion a desired temperature of fuel is achieved. Due to pressure fluctuation of the supplied gaseous fuel and also due to the dependence of temperature after the expansion from the composition of the gaseous fuel, the temperature after expansion may vary greatly. However, for such strongly varying temperatures at the inlet, a system as described in US 2014/0123742 A1 or EP 1 729 100 A1 is unsuitable. The described slow heat exchangers are normally not able to compensate great temperature oscillations.

A heat exchanger is slow and permits only slow temperature changes. Thus, the described conditioning by means of a heat exchanger is unsuitable for great load variations.

This means, in the state of the art, that after such a great load variation, a certain settling time has to be observed. During this time, the temperature is unstable and the flow sensors cannot perform a highly precise measurement. For an operation independent from inlet temperature variations, either the power density of the heat exchanger would have to be increased. However, this is not so easily accomplished, from a technical perspective, and requires, if possible at all, redesign of the heat exchanger. Keeping the power density constant, a much higher space would be required. A further possibility would possibly be to apply a more aggressive control behavior of the heat exchanger. This, however, means in turn a higher overshooting and undershooting and thus worse dynamic regarding possible changes of the setpoint temperature. An increase the heat exchanger in size, however, would only be useful in the case of liquids. In case of gaseous mediums, a flow variation directly causes a pressure variation and a change in the setpoint temperature. Thus, the heat exchanger would have to allow extremely rapid changes in the setpoint temperature, which however is not practically possible for a heat exchanger operating with a cooling liquid. To this end, the available power would have to be further increased, while keeping the mass constant. Increasing only the power would have no usefulness in this case. Alternatively, a last choice would be to set the controller of the heat exchanger still more aggressively, however causing a higher overshooting and undershooting. A precise and quick temperature regulation would thus not be possible.

In case of gaseous mediums, a flow variation directly causes a pressure variation and a change in the setpoint temperature. Thus, the heat exchanger would have to allow extremely rapid changes in the setpoint temperature, which however is not practically possible for a heat exchanger operating with a cooling liquid. Apart from this, a pure power increase hardly contributes to dynamics, since only power density is essential for a variation of setpoint values, but not the absolute power. A precise and fast temperature control in case of strong flow oscillations would thus not be possible with a conditioning using a heat exchanger. This is true for gaseous as well as for liquid mediums to be conditioned.

### SUMMARY

A first object of the present invention is thus to propose a method for controlling a conditioning unit of the above-said type, with which the temperature of a gaseous or liquid medium may be exactly set and kept constant in spite of great flow or pressure oscillations of the medium.

This object is achieved with a method in which the conditioning unit is controlled, in order to maintain preset setpoint temperature of the gaseous medium, wherein a control variable for the control of the conditioning unit is composed of a model part, which calculates the power required for the temperature control of the gaseous medium in the conditioning unit, and of a control part, which corrects the power calculated with the model part, wherein a control error based on the setpoint and actual temperature is introduced in an exponential form into the control part. With the model part the power required for the temperature control of the gaseous medium may be approximately calculated. For a precise control the control part is used, which corrects the model part. Due to the exponential contribution of the control error to the control part, the heat propagation in the conditioning unit is approximated, whereby a particularly precise control of the conditioning unit becomes possible.

The conditioning unit is provided, according to the invention, preferably with a base body, in which a medium line for the flow of gaseous medium is arranged, and a buffer storage for storing heat, wherein a temperature control unit is arranged between the base body and the buffer storage. This conditioning unit allows fast control interventions, which are required for a fast, precise and stable temperature control in the conditioning unit.

In gas engines, the flow rate of gaseous fuel may also strongly depend on the load of the gas engine. This in turn means that the heat exchangers in US 2014/0123742 A1 or EP 1 729 100 A1 for temperature control of the gaseous fuel in the preheat circuit and also in the measurement circuit should be able to manage these strong oscillations of flow rates. The described slow heat exchangers however are usually not suitable to this end, or should be correspondingly sized, which would increase their complexity and cost.

Apart from this, a temperature control for gaseous fuel with such heat exchangers would also be imprecise, wherein in particular a significant over-control (overheating or overcooling) after a variation of flow rate or pressure would occur.

Moreover, the usual systems for liquid fuels are also normally pressure-tight only up to 10 bar. For gaseous fuels, in case of preheating, a pressure tightness up to 300 bar is required. This rules out from the start conventional systems for a majority of application fields with gaseous fuels.

Known devices for precise measurement of consumption of liquid fuels of a combustion engine are thus less suitable, or conditionally suitable for gaseous fuels. Gaseous fuels thus require another approach, in order to measure the consumption of gaseous fuels in a precise manner and with reasonable resources.

Known are gas pressure control systems in natural gas networks for pressure reduction of the high transport pressure to a required consumer pressure, in which a gas flow measurement may also be integrated. Such gas pressure control systems usually comprise a natural gas preheater on the inlet side, often in the form of a water heating bath, through which the natural gas is supplied within pipes, or a water/natural gas heat exchanger. The natural gas preheater heats the natural gas before the expansion to consumer pressure in order to compensate a cooling due to the Joule-Thomson effect. Such gas pressure control systems, however, are not required to have a high precision of the initial pressure, nor have to comply with particular requirements regarding the initial temperature. In such pressure control systems, the effects of a slowly varying flow rate are also neglected. Fast, abrupt flow rate changes do not occur anyway in these gas pressure control systems.

The required heat power for the gas preheating of the supplied gaseous fuel to reach a desired temperature after the expansion may be calculated with a known formula and is used in such gas pressure control systems in order to control the natural gas preheater. This formula may also be used in a temperature control of a heat exchanger for controlling the temperature of the gaseous fuel. However, only for relatively slow flow rate variations a sufficient control precision may be obtained by that. For a gas pressure control systems, wherein the flow rate only varies slightly, and if only slowly, this may be sufficient. In an application, in which the flow rate may be subject to highly dynamic changes (such as in a combustion engine or gas turbine), the achievable precision of the temperature control with this known approach is insufficient, though.

Similar problems during a precise measurement of consumption always occur when a gaseous medium is supplied to a load for operating the load, wherein the gaseous medium is provided with a pressure higher than the required pressure in the load. Further examples, besides a combustion engine, in which similar requirements regarding precision are imposed, comprise a fuel cell, which is supplied with hydrogen, a rocket propulsion unit or a jet engine.

The control of the pressure of the gaseous medium is relatively easy to achieve with conventional pressure control units. The control of the temperature of the medium, on the contrary, is extremely difficult to achieve, due to the above-said problems.

It is therefore a further object of the present invention to provide a method for measuring the consumption of gaseous fuel of a load, which provides the gaseous fuel at the outlet at a temperature as constant as possible, in spite of highly dynamic changes of flow rate and/or pressure.

This object is achieved according to the invention by the fact that the gaseous medium flows along a gas path through a consumption measuring device and the consumption is measured with a consumption sensor and the gaseous medium's temperature is controlled before the consumption sensor with the conditioning unit, and the gaseous medium is expanded between the conditioning unit and the consumption sensor, and the conditioning unit is controlled according to the inventive control method.

Further preferred and advantageous embodiments of the method and of the conditioning unit are provided in the independent claims and the description of the invention.

The present invention is explained in the following with reference to FIGS. 1 to 5, which show exemplary, schematic and non-limiting advantageous embodiments of the invention. In particular

### BRIEF DESCRIPTION OF THE DRAWINGS

FIG. 1 shows a flow diagram of an inventive consumption measuring device,

FIG. 2 shows the consumption measuring device in an alternative embodiment,

FIG. 3 shows a conditioning unit,

FIG. 4 shows a conditioning unit with an active cooling in the buffer storage and

FIG. 5 shows a preferred embodiment of a consumption measuring device.

### DETAILED DESCRIPTION

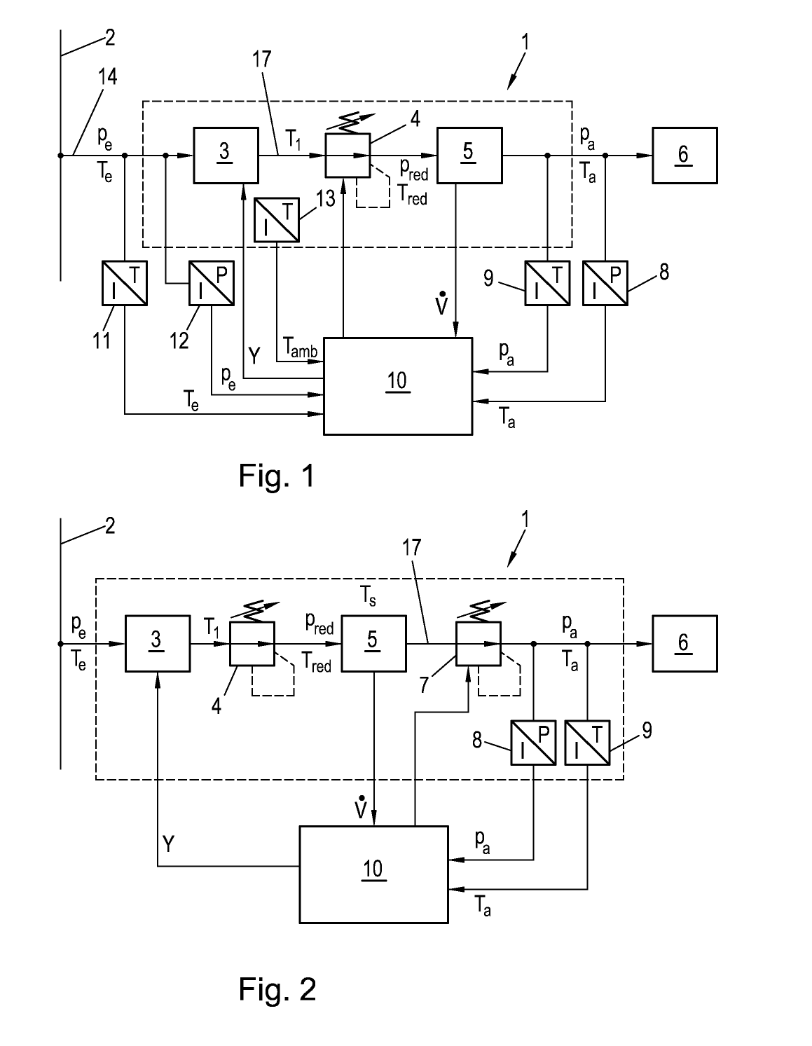

The invention is based on a structure similar to a known gas pressure control system, such as shown in FIG. 1. The consumption measuring device 1 draws a gaseous medium from a medium supply 2. The medium supply 2 may be a gas line or a medium container, for example, such as a gas bottle. The gaseous medium is drawn from the medium supply 2 usually at a variable inlet pressure pₑ and flows through the consumption measuring device 1 along a gas path 17. The inlet pressure pₑ may take values of up to 300 bar and more. The drawn gaseous medium is supplied to a conditioning unit 3 in the gas path 17, in which the gaseous medium is heated to a determined temperature T₁. Then, the heated gaseous medium is supplied to a pressure control unit 4, in which the gaseous medium is expanded to an expansion pressure p_{red}. Due to the expansion in the pressure control unit 4, also the temperature of the gaseous medium changes to an expansion temperature T_{red}. In the case of natural gas as gaseous medium, due to the Joule-Thomson effect, a cooling of the gaseous medium takes place. In case of hydrogen, the expansion may even cause a heating of the gaseous medium. After the expansion in the pressure control unit 4, the gaseous medium is supplied to a consumption sensor 5, such as a mass flow sensor or a flow rate sensor, for instance a known Coriolis sensor. The gaseous medium leaves the consumption measuring device 1 at an outlet pressure pₐ and an outlet temperature Tₐ and is supplied to a load 6, such as a combustion engine, a gas turbine or a fuel cell. The consumption of gaseous medium by the load 6 is thus measured by the consumption sensor 5. In order to get a precise measurement, a high temperature and pressure stability is required.

In the exemplary embodiment of FIG. 1, the outlet pressure pₐ and the outlet temperature Tₐ essentially correspond to the expansion pressure p_{red} and the expansion temperature Tᵣₑ after the pressure control unit 4. In an alternative embodiment, the expansion may also be implemented in two stages (or even in multiple stages), as explained with reference to FIG. 2. Herein, the gaseous medium is brought to an expansion pressure p_{red} and expansion temperature T_{red} before the consumption sensor 5, at which the consumption is measured. In the direction of flow after the consumption sensor 5 a second pressure control unit 7 is arranged, which expands the gaseous medium to the outlet pressure pₐ, thus also reaching the outlet temperature Tₐ. Certain consumption sensors 5, such as the preferred Coriolis sensors, show a higher precision at higher pressures and thus at higher densities of the gaseous medium. Thus, it may be advantageous to initially expand only up to a pressure, which provides a sufficiently high measurement precision, and to expand only afterwards to the required low outlet pressure pₐ.

In order to get a precise consumption measurement of the gaseous medium by the load 6, the outlet pressure pₐ and the outlet temperature Tₐ have to be kept as constant as possible. The outlet pressure pₐ and the outlet temperature Tₐ, however, strongly depend on the inlet pressure and inlet temperature Tₑ, the composition of the supplied gaseous medium (due to the Joule-Thomson effect) as well as the flow rate, which may vary strongly with time, but also in amplitude. In order to compensate these effects, on one hand, a control of the outlet pressure pₐ and in particular a highly dynamic temperature control of the conditioning unit 3 is required.

The control of the outlet pressure pₐ may be performed with acceptable precision by means of conventional pressure control units 4, 7, such as adjustable pressure control valves for example. The outlet pressure pₐ is thus preferably controlled in a higher-level pressure control loop. To this end, at the outlet of the consumption measuring device 1 a pressure sensor 8 may be provided, which detects the outlet pressure pₐ and supplies the same to a control unit 10, preferably in digital form. The control unit 10 controls the first pressure control unit 4 (FIG. 1), or the first and/or second pressure control unit 4, 7 (FIG. 2), in order to adjust the desired or predetermined outlet pressure pₐ. In the example of FIG. 2, the first pressure control unit 4 is set, for example, to a constant expansion pressure p_{red} and the outlet pressure pₐ is only controlled by the second pressure control unit 7.

In order to control the temperature, the outlet temperature Tₐ may be detected by a temperature sensor 9 and supplied to the control unit 10, preferably in a digital form. It is to be noted that the invention is described in the following in the case of measurement of outlet temperature Tₐ, but that, in principle, the temperature at any position in the consumption measuring device 1 might be used. In particular, instead of the outlet temperature Tₐ, also the expansion temperature T_{red} might be used, as well as temperature T₁ after the conditioning unit 3 or temperature T_{S} in the consumption sensor 5. The control unit 10 calculates, based on measured temperature, such as the outlet temperature Tₐ, temperature T₁ after the conditioning unit 3, expansion temperature T_{red} or temperature T_{S} in the consumption sensor 5, a control variable Y for the conditioning unit 3, by which the conditioning unit 3 is controlled. To this end, the control unit may also be provided with the actual flow rate \dot{V}, which is measured by the consumption sensor 5.

The desired outlet temperature Tₐ is thus controlled by the conditioning unit 3 depending on the actual flow rate \dot{V}, and also on the actual outlet pressure pₐ. In order to allow a precise control of the outlet temperature Tₐ in the event of a highly dynamically oscillating flow rate \dot{V}, a special conditioning unit 3 is provided, which is combined with a special control method.

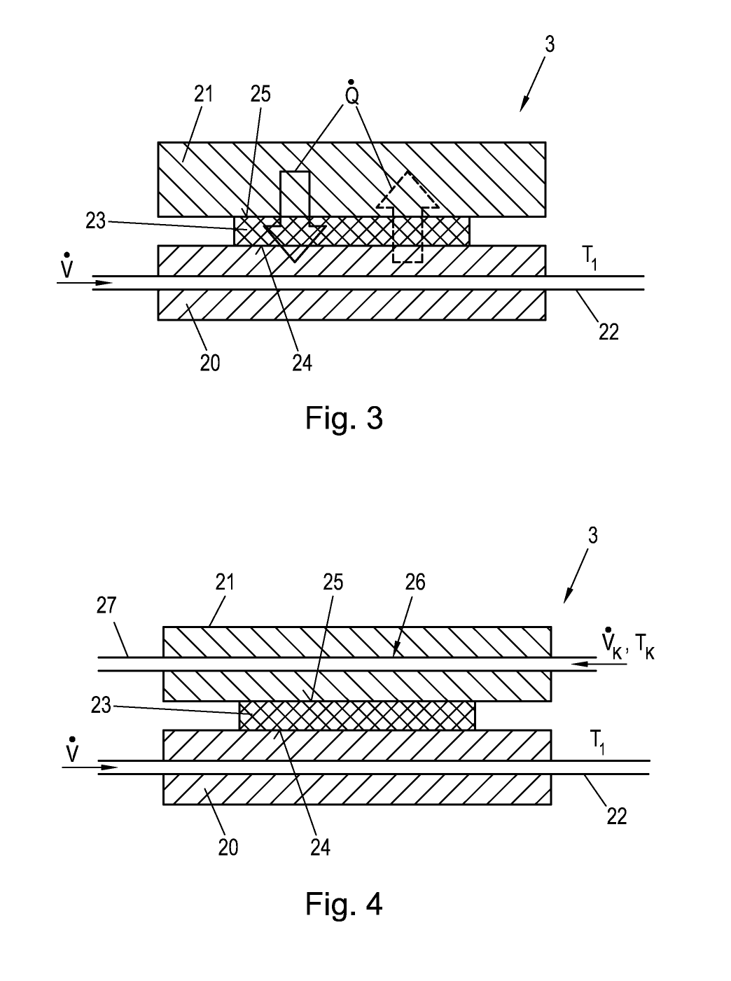

The conditioning unit 3, as schematically shown in FIG. 3, is provided with a base body 20, through which a medium line 22 is conducted, through which the gaseous medium to be conditioned flows. At the base body 20 a temperature control unit 23 is arranged, at which, in turn, a buffer storage 21 for storing heat is arranged. The base body 20 is not directly in contact with the buffer storage 21, but is thermally separated by the temperature control unit 23. The buffer storage 21 is preferably implemented as a cooling body having a certain storage mass. Thus, the cooling body is not designed for maximum heat dissipation, as usual for cooling bodies, but it has to store a certain amount of heat to be dissipated, at least for a certain period of time. The temperature control unit 23 is used for controlling the temperature of the base body 20 and thus of the flowing medium. To this end, the temperature control unit 23 is able to heat and cool the base body 20.

The temperature control unit 23 is advantageously implemented as at least one thermoelectric module (Peltier element), preferably as a plurality of thermoelectric modules. A thermoelectric module is notoriously a semiconductor element, which is arranged between a first heating surface 24 and a second heating surface 25. Depending on the polarity of the electric voltage supplied to the semiconductor element, either the first heating surface 24 is warmer than the second heating surface 25 or vice versa. Such a thermoelectric module may thus heat or cool the base body 20 depending on the polarity of the supply voltage. Since the structure and functionality of such thermoelectric modules are sufficiently known and such thermoelectric modules are available on the market in different power classes, a detailed description is omitted.

If an electric supply voltage is applied on a thermoelectric module, one of the heating surfaces 24, 25 of the thermoelectric module is cooled, as known, whereas the opposed heating surface warms up. The maximum temperature spread between both heating surfaces 24, 25 depends on the operating temperature (temperature on the warmer heating surface) of the thermoelectric module. The higher the operating temperature, the higher the maximum achievable temperature spread between cool and warm heating surface. Thus, with available thermoelectric modules, temperatures of up to 200° C. on the warm heating surface may be achieved, wherein the cool heating surface does not rise above 100° C. By a simple change of polarity of the supplied voltage, a fast switching between cooling and heating may be achieved. Since the gaseous medium flowing through the conditioning unit 3 has to be temperature-controlled, a heating means that the heating surface 24 contacting the base body 20 is warmer than the opposed heating surface 25. Thus, a cooling means that the heating surface 25 is the warmer heating surface and the heating surface 24 contacting the base body is the cooler one.

In order to control the temperature of the gaseous medium, however, it is not strictly necessary to change the polarity of the supply voltage, if the temperature of the gaseous medium has to be reduced or increased. To this end the temperature spread between the heating surfaces 24, 25 may also be used. Smaller control interventions may then occur through the temperature spread, while stronger control interventions preferably occur by inverting the polarity of the voltage supplied to the thermoelectric module.

The control over the temperature spread is supported by the fact that the buffer storage 21 during heating operation, i.e. when the medium in the medium line 22 has to be heated, is used as a heat storage. In case of constant voltage supply to the thermoelectric modules, a stable temperature spread sets in on the thermoelectric modules. As soon as less thermal energy or heat is required for controlling the temperature of the medium, the supply voltage on the thermoelectric modules is reduced, whereby also the temperature spread is reduced. Thus, the temperature on the heating surface 24 contacting the base body 20 of the thermoelectric module is reduced. At the same time, the temperature on the opposed heating surface 25 is increased. Thus, a temperature gradient is formed between the heating surface 25 and the contacting buffer storage 21, whereby heat flows into the buffer storage 21 (indicated by the heat flow \dot{Q}) and due to thermal storage mass, is not immediately dissipated into the environment, but temporarily stored (at least for a limited time). This temporarily stored heat is available for the temperature control as a support, when again more thermal energy is required for controlling the temperature of the medium. In this case, the supply voltage would be increased again, whereby the temperature spread on the thermoelectric modules rises again. Thus, the temperature on the heating surface 25, which contacts the buffer storage 21, decreases with respect to temperature of buffer storage 21. Thus, an inverted temperature gradient is formed, which causes the thermal energy stored in the buffer storage 21 to flow into the base body 20 (indicated by the heat flow \dot{Q}) and thus supports the thermal control of medium by the thermoelectric modules. Thus, a very fast and precise reaction to fast load changes or temperature variations is obtained, and a typical thermal over-regulation may be essentially avoided. It is advantageous, to this end, if the thermal storage mass of the buffer storage 21 is adapted to the thermal storage mass of the base body 20 and the medium line 6 arranged within, in order to use in the best possible way above said effects.

Although the conditioning unit 3 has been described as a temperature control unit 23 having a thermoelectric module, it is obvious that also other embodiments of a temperature control unit 23 may be envisaged. The temperature control unit 23 has only to be capable of varying the temperature spread between the heating surfaces 24, 25. From a physical point of view, the operation of a thermoelectric module corresponds to a heat pump, which draws thermal energy from an area at lower temperature and transmits it to a system to be heated at higher temperature. The changing of polarity of the supplied voltage corresponds to the provision of two heat pumps, which operate in a mutually opposed way. Thus, in principle, any apparatus which may be defined as a heat pump can be considered as the temperature control unit 23.

In order to make use of this advantage of the conditioning unit 3 also from a control perspective, which represents a precondition for a fast and precise control, according to the invention, the described heat flow \dot{Q} between the buffer storage 21 and the base body 20, through which the medium flows, is taken into account in the control. To this end a controller is designed, which determines a control variable Y for the conditioning unit 3 based on a setpoint temperature setting Tₛₒₗₗ. The conditioning unit 3 is controlled by the control variable Y and ensures a stable and constant temperature of the medium.

The control variable Y is composed of a model part A and a control part R, i.e. Y=A+R. The model part A models the conditioning unit 3 and allows the calculation in the best possible way of the energy or power Pᵥ required for controlling the temperature of the medium in the conditioning unit 3 and the conversion of the same into a control variable for performing the control. The power P_{G} required for the conditioning of a gaseous medium, for obtaining, after a expansion, a setpoint temperature Tₛₒₗₗ, may be calculated based on the known equation:

$${P}_{G} = \frac{\dot{V} \cdot {H}_{G} \cdot ( {T}_{hot} - {T}_{e} )}{3 , 6} [ \frac{kJ}{h} ] with {T}_{hot} = {T}_{soll} + Δ {p}_{G} \cdot {μ}_{JT}$$

Without the Joule-Thomson effect, the power P_{G} is reduced to the power required for controlling the temperature (heating or cooling) of the medium. The actual flow rate \dot{V} is measured and provided by the consumption sensor 5. The specific thermal capacity H_{G} of the medium is a known constant. The inlet temperature Tₑ may be measured by an appropriate temperature sensor 11, such as a PT100 sensor. The pressure difference Δp_{G} indicates the expansion from inlet pressure pₑ to expansion pressure p_{red}, which may both be measured by suitable pressure sensors 8, 12, thus Δp_{G}=(pₑ−p_{red}). In an embodiment according to FIG. 2, the expansion pressure p_{red} may also be known. μ_{JT} indicates the known Joule-Thomson coefficient of the gaseous medium. The Joule-Thomson coefficient for a liquid is set equal to zero.

Optionally, a power loss P_{L} in the conditioning unit 3 may also be considered. For a very precise and fast control, the power loss P_{L} should be taken into account. The power loss P_{L} may be modeled, for example, as the heat dissipated from the conditioning unit 3 into the environment at ambient temperature T_{amb}. The ambient temperature T_{amb} may also be measured by a suitable temperature sensor 13, such as a PT100 sensor. The power loss P_{L} may then be calculated, based on an empirical constant obtained from the concrete embodiment of the conditioning unit 3 and considered as known, according to following equation:

$${P}_{L} = {k}_{PL} \vert {T}_{hot} - {T}_{e} \vert [ \frac{kJ}{h} ]$$

The power Pᵥ required for controlling the temperature in the conditioning unit 3 is then obtained from P_{V}=P_{G} [+P_{L}], which may be used as model part A. In order to derive from that an easily processible control variable, the required power Pᵥ may also be related to the maximum power Pᵥₘₐₓ available in the conditioning unit 3, thus model part becomes

$$A = \frac{{P}_{V}}{{P}_{V , max}} .$$

Thus, the model part A is a parameter in the range of [0, 1] or [−1, 1] if in the conditioning unit 3 switching between heating and cooling is possible.

In a concrete embodiment of the conditioning unit 3 with a thermoelectric module as a temperature control unit 23, the required power Pᵥ may also be converted into a supply voltage Uᵥ, which has to be applied on the thermoelectric module. With an Ohmic resistance R_{CU} in the thermoelectric module in the conditioning unit 3, the supply voltage Uᵥ may be calculated from the known relationship U_{V}=\sqrt{P_{C}·R_{CU}}. Similarly, the model part A may be calculated related a maximum available supply voltage U_{v,max} as

$$A = \frac{{U}_{V}}{{U}_{V , max}} .$$

The Ohmic resistance R_{CU} of a thermoelectric module, however, is usually unknown, and also dependent on temperature. In order to determine the Ohmic resistance R_{CU}, the empirical relationship was found based on experiments,

$${R}_{CU} = {R}_{CU 20} + \frac{{R}_{CU 150} - {R}_{CU 20}}{150 - 20} ( {T}_{ist} - 20 )$$

from which the Ohmic resistance R_{CU} may be calculated, if the actual temperature Tᵢₛₜ (which may be readily measured) of the thermoelectric modules is known. Therein, R_{CU20} and R_{CU150} are empirical constants, which indicate the Ohmic resistance R_{CU} of the thermoelectric module at a temperature of 20° and 150° C.

The control part R of control variable Y allows a highly dynamic precise control of outlet temperature Tₐ (or another temperature, as mentioned) by using the heat amount available in the buffer storage 21. Since with model part A the power Pᵥ required for temperature control, for obtaining the setpoint temperature Tₛₒₗₗ, is already approximately adjusted, the control part R has only to perform small corrections of control variable Y, in order to obtain the desired precise control behavior.

As already mentioned, in the conditioning unit 3 according to the invention, the heat flow \dot{Q} between base body 20 and buffer storage 21 plays a decisive role. In order to consider this heat flow \dot{Q} in the control, the control error F is not linearly introduced into the control part R, but in an exponential form, thus R=f(e^{F}). The reason for this lies in the solution to the heat conduction equation, which also contains an exponential component. The control deviation F in the present embodiment is the difference between the setpoint temperature Tₛₒₗₗ and the actual temperature Tᵢₛₜ.

Concerning this it is to be noted that both the setpoint temperature Tₛₒₗₗ and the actual temperature Tᵢₛₜ refer to the temperature to be controlled, thus for example the outlet temperature Tₐ, the temperature T₁ after the conditioning unit 3, the expansion temperature T_{red} or the temperature T_{S} in the consumption sensor 5. However, it is indeed possible to refer the setpoint temperature Tₛₒₗₗ and the actual temperature Tᵢₛₜ in model part A and control part R to different temperatures, thus for example T_{S} in the consumption sensor 5 in model part A and outlet temperature Tₐ in control part R.

For the control part R, a classic control related approach may be chosen, by which the control part R, in order to form a PI controller, is composed of a proportional part Y_{P} and an integral part Y_{I}, thus R=Y_{P}+Y_{I}. In the following, a possible concrete embodiment of the control part R, or the proportional part Y_{P} and the integral part Y_{I}, is described.

A conventional proportional controller is composed of an amplification factor K_{P}, which weighs the control error F, thus K_{P}·F. A conventional integral controller is composed of an amplification factor K_{I}, which weighs the control error F as a function of time, thus K_{I}·F·t, with amplification factor K_{I} as the inverse value of reset time Tₙ.

In the proportional part Y_{P} and in the integral part Y_{I} of the inventive controller, the control error F is introduced as exponential functions f_{P}(e^{F}) or f_{I}(e^{F}) of the control error F. Thus, the proportional part Y_{P}, in the simplest case, is obtained as Y_{P}=K_{P}·f_{P}(e^{F}) and the integral part Y_{I} as Y_{I}=K_{I}·f_{I}(e^{F})·t. For a time-discrete controller with a sampling time Δt (of 10 ms, for example) the integral controller may also be described in the form Y_{I}(n)=Y_{I}(n−1)+ΔY_{I}, with ΔY_{I}=K_{I}·f_{I}(e^{F})·Δt. By using the exponential function of the control error R, the heat propagation in the conditioning unit 3 is approximated.

As already described, the energy introduced in the conditioning unit 3, is used, on one hand for heating the gaseous medium and on the other side for heating the entire conditioning unit 3. With a given energy supply, the temperature increase of the gaseous medium is thus slower than the temperature reduction of the gaseous medium. The temperature increase, as said, is supported by heat stored in the buffer storage 21, so that this effect is already weakened by this fact.

In order to compensate this asymmetric characteristic of the conditioning unit 3, the proportional part Y_{P} and the integral part Y_{I} may also be corrected by a suitable corrective function Y_{PowerCor}, which yields a corrected proportional part Y_{Pcor} and a corrected integral part Y_{Icor}:

$${Y}_{Pcor} = H ( {T}_{soll} - {T}_{ist} ) \cdot {Y}_{P} \cdot {Y}_{PowerCor} + H ( {T}_{ist} - {T}_{soll} ) \cdot \frac{{Y}_{P}}{{Y}_{PowerCor}}$$

$${Y}_{Icor} = H ( {T}_{soll} - {T}_{ist} ) \cdot {Y}_{I} \cdot {Y}_{PowerCor} + H ( {T}_{ist} - {T}_{soll} ) \cdot \frac{{Y}_{I}}{{Y}_{PowerCor}}$$

Herein, H(x) is the known Heaviside function, which maps the real numbers onto the set {0, 1} with H(x)=0 for x<0 and H(x)=1 for x≥0. This means that due to the correction, the proportional part Y_{P} and the integral part Y_{I} are amplified, if Tₛₒₗₗ>Tᵢₛₜ, i.e. when the temperature in the gaseous medium has to be increased. The proportional part and the integral part are weakened if Tᵢₛₜ>Tₛₒₗₗ, i.e. when the temperature of the gaseous medium has to be reduced. As corrective function_Y_{PowerCor}, for example

$${Y}_{PowerCor} = \frac{1}{1 - \vert A \vert}$$

can be used with above said model part A. Thus, the correction would be increased by an increase of the control intervention, i.e. by an increase of the model part A. Obviously, this expression of the corrective function Y_{PowerCor} presupposes that model part A is normalized in the range [0,1] or [−1,1].

In a preferred embodiment, the proportional part Y_{P} is obtained as equation

$${Y}_{P} = H ( \frac{1}{{K}_{P}} \vert {T}_{soll} - {T}_{ist} \vert ) \cdot sign ( {T}_{soll} - {T}_{ist} ) \cdot ( {e}^{{K}_{p} \vert {T}_{ist} - {T}_{soll} \vert \cdot ln ( 2 )} - 1 ) + H ( ( {T}_{soll} - {T}_{ist} ) - \frac{1}{{K}_{P}} ) - H ( ( {T}_{ist} - {T}_{soll} ) - \frac{1}{{K}_{P}} )$$

The exponential function f_{I}(e^{F}) in the integral part Y_{I} is obtained in a preferred embodiment as equation

$${f}_{1} ( {e}^{F} ) = H ( \frac{1}{{K}_{P}} - \vert {T}_{soll} - {T}_{ist} \vert ) \cdot sign ( {T}_{soll} - {T}_{ist} ) \cdot ( {e}^{{K}_{p} \cdot \vert {T}_{soll} - {T}_{ist} \vert \cdot ln ( 1 + ρ )} - 1 ) + H ( ( {T}_{soll} - {T}_{ist} ) - \frac{1}{{K}_{P}} ) \cdot sign ( {T}_{soll} - {T}_{ist} ) \cdot ( {e}^{\frac{σ}{\vert {T}_{soll} - {T}_{ist} \vert}} - 1 )$$

Herein, it is to be noted that, for reasons of simplification, also in the integral part Y_{I} the amplification factor K_{P} of the proportional controller is used, which is obviously not necessary. Instead, the amplification factor K_{I} of the integral controller may obviously be used.

For the time-discrete case, the integral part Y_{I} may then again be expressed as Y_{I}(n)=Y_{I}(n−1)+ΔY_{I}, with ΔY_{I}=K_{I}·f_{I}(e^{F})·Δt.

Herein, H(x) is again the Heaviside function, and sign is the signum function, which maps the real numbers into the set {−1, 0, 1}, with sign(x)=−1 for x<0, sign(x)=0 for x=0 and sign(x)=1 for x>0. The parameter σ is defined as

$$σ = {T}_{P} \cdot ln ( \frac{1}{{e}^{\vert ln ( 1 + ρ ) \vert}} - 1 )$$

and ρ=0.318366. The function f_{I}(e^{F}) for the integral part Y_{I} has been selected in order to be continuous in the entire range with an exponential profile. To this end, the function has been portioned in two parts. A first portion with a logarithmic curve in case of large control errors and a second portion with an exponential curve, in case of smaller errors F. The transition between the first and second portion takes place at a point ρ, where the slope of both curves is identical, in order to obtain a continuous function.

The control variable Y, which is determined by the controller, thus follows from Y=A+R=A+Y_{P}+Y_{I}. Here, it is to be noted that the use of a proportional part Y_{P} and of an integral part Y_{I} is preferred but not required. There may also be used only the proportional part Y_{P} or the integral part Y_{I}. Moreover, in control variable Y a damping factor Y_{Df1} may also be considered. The damping factor Y_{Df} may comprise a first damping factor Y_{Df1} (for example an empirical value), in order to prevent an overheating of the conditioning unit 3. Moreover, the damping factor Y_{Df} may also comprise a second damping factor Y_{Df2}, which may also damp a setpoint value overshooting, according to the principle of maximum value damping, for example. The damping factor Y_{Df} is then equal to Y_{Df}=Y_{Df1}+Y_{Df2}. Both damping factors are optional and may be used independently from each other. In case of use of a damping factor Y_{Df}, the calculated control variable Y is

Y=(A+R)·Y_{Df}=(A+Y_{P}+Y_{I})·Y_{Df}

With this controller, in combination with the specially designed conditioning unit 3, the desired temperature may be set with high precision and a high temperature stability may be achieved, which is the precondition, in case of dynamic flows of medium, for a precise determination of consumption values (mass flow, volumetric flow).

Here, it is to be noted that above said control is independent from a concrete application. Although the control has been described in connection with a consumption measurement of a gaseous medium, the conditioning unit 3 may be controlled in general terms, as described, and may thus be suitable also for other applications, in which a medium, in particular also liquid mediums, has to be temperature controlled. This is possible, in the first place, because the control may be applied on any temperature, i.e. also on temperature T₁ after the conditioning unit 3, for example.

However, with this controller, it is also possible to follow temperature curves or temperature characteristic curves of setpoint temperature Tₛₒₗₗ, even as a function of the outlet pressure pₐ or inlet pressure pₑ and also as a function of flow rate \dot{V}. Also, dependencies of the outlet pressure pₐ from flow rate \dot{V} may be imitated, for example, by means of a corresponding characteristic curve. If the flow rate \dot{V} depends on the outlet pressure pₐ or the inlet pressure pₑ, the controller could also be used to set a desired flow rate \dot{V} through the pressure regulation. Thus, with this controller it is possible to simulate an original structure, as used for example on a vehicle, and even a drive with the vehicle.

Here, it is again to be noted that the setpoint temperature Tₛₒₗₗ may be any temperature in the consumption measuring device 1, but also a temperature outside of the consumption measuring device 1. However, the outlet temperature Tₐ is the preferred setpoint temperature Tₛₒₗₗ. Similarly, the outlet pressure pₐ may be measured within the consumption measuring device 1 or outside, for example near a load 6.

The described control is suitable both for a control based on a temperature spread, and for a control with an alternate heating and cooling. In case of thermoelectric modules as temperature controlling units 23, the supply voltage polarity is switched, when the control variable Y changes sign. The control variable Y is preferably normalized within the range [−1,1] as described.

In case of a hydrogen as gaseous medium, due to the expansion in the pressure control unit 4, a heating takes place. In this case the inlet temperature Tₑ determines if the conditioning unit 3 has to cool or to heat. The same essentially holds for liquid mediums.

In order to support the cooling, an additional cooling device 26 may be provided in the buffer storage 21 of the conditioning unit 3, for instance as a cooling line 27 through which a cooling medium flows. The control may then be extended with a control of the cooling device 26, through which the active cooling by the cooling device 26 is taken account of. This control then controls the cooling device 26 in that, for example, the flow rate \dot{V}_{K} (for instance, through an adjustment valve or the pressure) and/or the temperature T_{K} of the cooling medium is varied. To this end, a control variable Y_{C} is determined, with which the cooling device 26 is controlled.

The control of the active cooling is preferably provided with certain properties. The active cooling by means of the cooling device 26 has cover the base load, while the temperature control unit 28 has to compensate highly dynamic disturbances. It is however the object that the temperature control unit 28 always bears a part of the cooling load, in order to avoid that the temperature control unit 28 has to operate around the zero point, which may cause a continuous switching between cooling and heating. In case of Peltier elements as temperature control unit 28, this would mean a continuous switching of polarity, which may also cause permanent damage to the Peltier elements. Apart from this, in the event of operating around the zero the advantage of the buffer storage for controlling the conditioning unit 3 would also be lost. Last but not least, the controlling of the active cooling shall be as decoupled as possible from the controlling of the conditioning unit 3, in order to avoid a negative influence on this control.

In order to fulfil these requirements, a controller is proposed, in which a temperature difference ΔT_{K} is introduced in an exponential form. The temperature difference ΔT_{K} for which the control takes place is a difference between a temperature T_{TE} of the temperature control unit 28 (which can be measured), preferably on the side of the buffer storage 21 (heating surface 25), and the actual temperature T_{K} of the cooling medium. In order to prevent the temperature control unit 28 from operating around the zero, a predefined dead band T_{totb} may also be defined, which correct the temperature T_{TE} of the temperature control unit 28. Thus, a corrected temperature T_{KH} of the temperature control unit 28 is obtained, equal to T_{KH}=T_{TE}−T_{Totb}, and the temperature difference ΔT_{K}=T_{KH}−T_{K}. A P-controller may thus be designed, which determines a control variable Y_{CP} for the cooling device 26 as follows.

$${Y}_{CP} = H ( - Y ) \cdot H ( \frac{1}{{K}_{P}} - \vert {T}_{KH} - {T}_{K} \vert ) \cdot H ( {T}_{KH} - {T}_{K} ) \cdot ( {e}^{{K}_{CP} \vert {T}_{KH} - {T}_{K} \vert \cdot ln ( 2 )} - 1 ) + H ( ( {T}_{KH} - {T}_{K} ) - \frac{1}{{K}_{CP}} )$$

Herein, H is again the Heaviside function and Y is the control variable from the controlling of conditioning unit 3. K_{CP} is an amplification factor of the P-controller.

In order to ensure a decoupling between the control of the conditioning unit 3 and of the cooling device 26, the reaction time in controlling the cooling device 26 should be longer than the reaction time for controlling the conditioning unit 3. In order to provide the controlling of the cooling device 26 with a defined delay time, a filter G may be used. The filter G receives as an input signal the control variable Y_{CP} for the cooling device 26 and calculates a filtered control variable Y_{CPF}, which is then used as the actual control variable for the cooling device 26, thus Y_{CPF}=G(Y_{CP}).

To this end, various known filters G may be used. In this context, a Gauss filter known from the imaging field has been successful, since such a filter notoriously lacks any overshooting and maximum increase time. Moreover, all frequencies above a threshold are damped. Such a Gauss filter is well known, so that its details are omitted here. It is also known that the calculations on which the Gauss filter is based are complex and require a lot of computing power, which is a drawback in the case of a control application. However, solutions are already known in the art, in order to minimize the computation times. So called discrete Gauss nuclei or sampled Gauss nuclei are used in this case.

The embodiment with the active cooling in the buffer storage is particularly interesting for liquid, but also for gaseous mediums. A large control range is achieved in this way for the conditioning unit 3, with Peltier elements as temperature control units 28, for example between −40 and 150° C. The conditioning unit 3 can provide the required performance in the whole control range, and still control the temperature in a highly dynamic and extremely precise way.

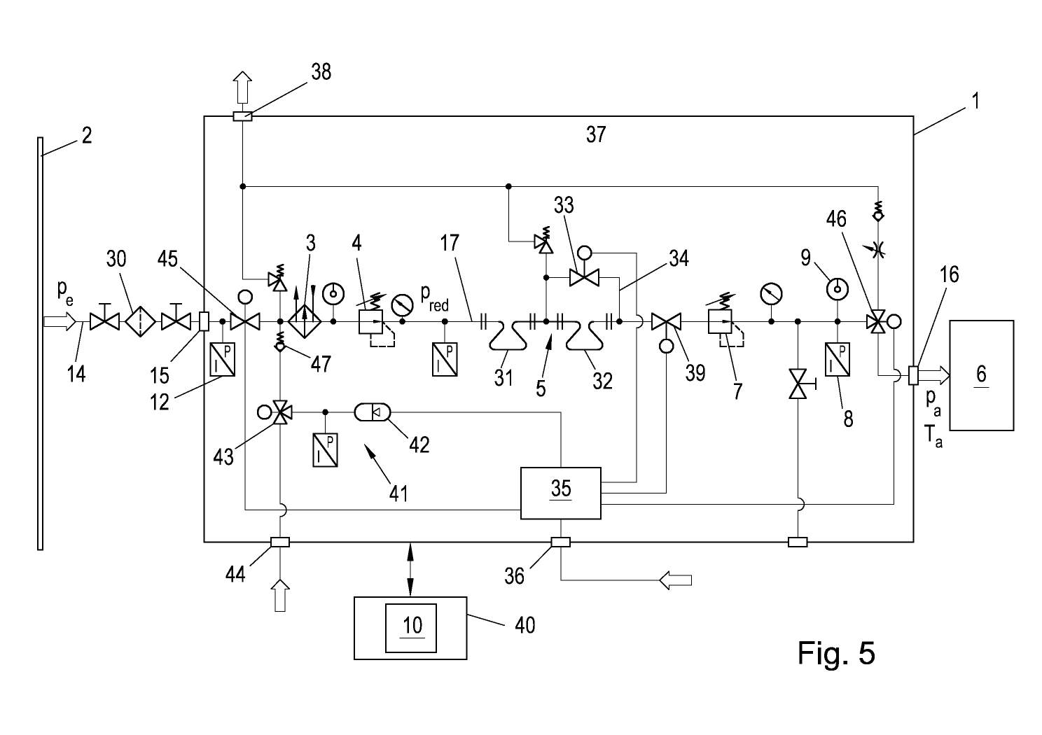

A preferred embodiment of the consumption measuring device 1 is now described, by means of FIG. 5, for a gaseous medium. The gaseous medium, at an inlet pressure pₑ, is drawn from a medium supply 2 and is supplied through an inlet line 14 and an inlet connection 15 to the consumption measuring device 1. On the inlet side, either outside of or inside the consumption measuring device 1, a gas filter 30 may also be provided. The temperature of the gaseous medium is controlled in a conditioning unit 3 and in a following pressure control unit 4 the pressure of the gaseous medium is expanded to an expansion pressure p_{red}. The expanded gaseous medium then flows through the consumption sensor 5, in which the consumption (mass flow, volumetric flow) is measured. The second pressure control unit 7 is positioned after the consumption sensor 5, and sets the desired outlet pressure pₐ. The conditioned gaseous medium may then be drawn through an outlet 16 and supplied to a load 6, for example.

All functions and components described in the following are controlled by a master control unit 40, in which the control unit 10 is also implemented. Also the sensors provide their measurement values to the master control unit. For clarity, the required control lines and measurement lines were omitted in FIG. 4.

The consumption sensor 5 is composed in this case of two or more series connected Coriolis sensors 31, 32. Both Coriolis sensors 31, 32 have different measurement ranges. Thus, depending on consumption, the measurement may be switched on the optimal Coriolis sensor (in the sense of measurement precision). This takes place here through a bypass valve 33, which is disposed in a bypass line 34 around the second Coriolis sensor 32. The switching valve 33 is here actuated by compressed air. To this end, a compressed air valve block 35 is provided, which is connected, via a compressed air connection 36, to an external compressed air supply. The second Coriolis sensor 32 may thus be added or removed by actuating the bypass switching valve 33. If both Coriolis sensors 31, 32 are active, a plausibility check of the measurement result may be obtained in the intersecting measurement range, which may be used for a self-diagnosis.

In the consumption measuring device 1, an overflow line 37 is also provided, which is connected to the overflow connection 38. The overflow line 37 is connected in the consumption measuring device 1 through overpressure valves to the gas path for the gaseous medium. In this way, the consumption measuring device 1 may be protected from erroneous overpressures.

On the downstream side of the consumption sensor 5 a zero-adjustment valve 39 is arranged. Thus, the zero point of the consumption sensor 5 may be verified. To this end, the zero-adjustment valve 39 is closed (here, again by compressed air) and the measurement value of the consumption sensor 5 is evaluated with a volumetric flow equal zero. If the measured value exceeds a threshold, an internal sensor adjustment may be activated, in order to set the zero point. The zero-point drift of the consumption sensor 5 may thus be compensated.

In the consumption measuring device 1, in the example shown, an inert gas purging 41 is also provided. To this end, an inert gas pressure storage 42 is provided, which may be connected through an inert gas switch valve 43 to the gas path of the gaseous medium through the consumption measuring device 1. The inert gas pressure storage 42 may be filled through an inert gas connector 44. The inert gas (nitrogen, for example) used for purging the consumption measuring device 1 may also be directly supplied through the inert gas connector 44.

In order to purge the consumption measuring device 1 with inert gas, the inlet side check valve 45 is closed and the outlet side switch valve 46 is switched on the overflow line 37. At the same time, the inert gas switch valve 43 is opened. Thus, the pressurized gaseous medium, remaining in the consumption measuring device 1 may escape through the overflow line 37. If the pressure is sufficiently reduced, the non-return valve 47 opens and the consumption measuring device 1 is purged by the inert gas, either until the inert gas pressure storage 42 is empty or for a determined period of time. After the purging, the consumption measuring device 1 is filed with inert gas, preferably with a slight overpressure, and is in a safe state. The inert gas purging increases the safety of the consumption measuring device 1 and may be activated, for example, in the event of a deactivation of the apparatus or in case of an emergency stop.

1. A method for the controlling a conditioning unit comprising a base body and a buffer storage, wherein a medium is supplied through the base body and a temperature control unit having a first heating surface and a second heating surface is arranged between the buffer storage and the base body, and wherein a temperature spread is set between the first heating surface and the second heating surface by means of the temperature control unit, wherein the conditioning unit is controlled in order to maintain a predetermined setpoint temperature (Tₛₒₗₗ) of the medium, wherein a control variable (Y) for the control of the conditioning unit is composed of a model part (A), which calculates the power (Pᵥ) required for the temperature control of the medium in the conditioning unit, and a control part (R), which corrects the power (Pᵥ) calculated by means of the model part (A), wherein a control error (F) based on the setpoint temperature (Tₛₒₗₗ) and an actual temperature (Tᵢₛₜ) is introduced in an exponential form into the control part (R).

2. The method according to claim 1, wherein the model part (A) calculates the power (Pᵥ) required for the temperature control based on the relationship
$${P}_{G} = \frac{\dot{V} \cdot {H}_{G} \cdot ( {T}_{hot} - {T}_{e} )}{3 , 6} with {T}_{hot} = {T}_{soll} + Δ {p}_{G} \cdot {μ}_{JT} .$$

3. The method according to claim 2, wherein in the model part (A), a power loss (P_{L}) of the conditioning unit is taken into account.

4. The method according to claim 1, wherein the control part (R) is composed of a proportional part (Y_{P}) and/or an integral part (Y_{I}), wherein the control error (F) is introduced in the form of exponential functions (f_{P}(e^{F}), f_{I}(e^{F})) of the control error (F) in the proportional part (Y_{P}) and/or in the integral part (Y_{I}).

5. The method according to claim 4, wherein the proportional part (Y_{P}) is formed by an amplification factor (K_{P}) and by the exponential function f_{P}(e^{F}).

6. The method according to claim 5, wherein the proportional part (Y_{P}) is calculated from the relationship
$${Y}_{P} = H ( \frac{1}{{K}_{P}} - \vert {T}_{soll} - {T}_{ist} \vert ) \cdot sign ( {T}_{soll} - {T}_{ist} ) \cdot ( {e}^{{K}_{p} \vert {T}_{ist} - {T}_{soll} \vert \cdot ln ( 2 )} - 1 ) + H ( ( {T}_{soll} - {T}_{ist} ) - \frac{1}{{K}_{P}} ) - H ( ( {T}_{ist} - {T}_{soll} ) - \frac{1}{{K}_{P}} )$$

7. The method according to claim 5, wherein the proportional part (Y_{P}) is corrected by a corrective function (Y_{PowerCor}), forming a corrected proportional part (Y_{Pcor}).

8. The method according to claim 7, wherein the corrected proportional part (Y_{Pcor}) is calculated from the relationship
$${Y}_{Pcor} = H ( {T}_{soll} - {T}_{ist} ) \cdot {Y}_{P} \cdot {Y}_{PowerCor} + H ( {T}_{ist} - {T}_{soll} ) \cdot \frac{{Y}_{P}}{{Y}_{PowerCor}} .$$

9. The method according to claim 4, wherein the integral part (Y_{I}) is formed by an amplification factor (K_{I}) and the exponential function f_{I}(e^{F}) and time (t).

10. The method according to claim 4, wherein the integral part (Y_{I}) is formed, for a time-discrete controller with sampling time (Δt), by an amplification factor (K_{I}) and the exponential function f_{I}(e^{F}) and sampling time (Δt).

11. The method according to claim 9, wherein the exponential function f_{I}(e^{F}) in the integral part (Y_{I}) is calculated from the relationship
$${f}_{I} ( {e}^{F} ) = H ( \frac{1}{{K}_{I}} - \vert {T}_{soll} - {T}_{ist} \vert ) \cdot sign ( {T}_{soll} - {T}_{ist} ) \cdot ( {e}^{{K}_{I} \cdot \vert {T}_{soll} - {T}_{ist} \vert \cdot ln ( 1 + ρ )} - 1 ) + H ( ( {T}_{soll} - {T}_{ist} ) - \frac{1}{{K}_{I}} ) \cdot sign ( {T}_{soll} - {T}_{ist} ) \cdot ( {e}^{\frac{- σ}{\vert {T}_{soll} - {T}_{ist} \vert}} - 1 )$$

12.-27. (canceled)

28. The method according to claim 9, wherein the integral part (Y_{I}) is corrected by a corrective function (Y_{PowerCor}) in order to form a corrected integral part (Y_{Icor}).

29. The method according to claim 28, wherein the corrected integral part (Y_{Icor}) is calculated from the relationship
$${Y}_{Icor} = H ( {T}_{soll} - {T}_{ist} ) \cdot {Y}_{I} \cdot {Y}_{PowerCor} + H ( {T}_{ist} - {T}_{soll} ) \cdot \frac{{Y}_{I}}{{Y}_{PowerCor}} .$$

30. The method according to claim 1, wherein in the control variable (Y) a damping factor (Y_{Df}) is considered.

31. The method according to claim 1, wherein a cooling device is arranged in the buffer storage, which supplies cooling medium through the buffer storage, and the cooling device is controlled in that a control variable (Y_{CP}) is calculated, wherein a temperature difference (ΔT_{K}) between a temperature (T_{TE}) of the temperature control unit and an actual temperature (T_{K}) of the cooling medium is introduced in an exponential form into the control variable (Y_{CP}).

32. The method according to claim 31, wherein the temperature (T_{TE}) of the temperature control unit is corrected by a dead band (T_{totb}).

33. The method according to claim 32, wherein the control variable (Y_{CP}) is calculated according to
$${Y}_{CP} = H ( - Y ) \cdot H ( \frac{1}{{K}_{CP}} - \vert {T}_{KH} - {T}_{K} \vert ) \cdot H ( {T}_{KH} - {T}_{K} ) \cdot ( {e}^{{K}_{CP} \vert {T}_{KH} - {T}_{K} \vert \cdot ln ( 2 )} - 1 ) + H ( ( {T}_{KH} - {T}_{K} ) - \frac{1}{{K}_{CP}} )$$

34. The method according to claim 31, wherein the calculated control variable (Y_{CP}) is filtered, and the filtered control variable (Y_{CPF}) is used for controlling the cooling device.

35. The method according to claim 34, wherein the filtering is performed with a Gauss filter (G).

36. The method according to claim 1 for measuring the consumption of a gaseous medium, wherein the gaseous medium flows along a gas path through a consumption measuring device and wherein the consumption is measured by a consumption sensor and the temperature of the gaseous medium is controlled before the consumption sensor with the conditioning unit, and the gaseous medium is expanded between the conditioning unit and the consumption sensor, and the conditioning unit is controlled according to the control method.

37. The method according to claim 36, wherein the pressure of the gaseous medium after the conditioning unit is set by a pressure control unit.

38. A consumption measuring device for measuring the consumption of a gaseous medium, with an inlet connection, at which the gaseous medium is supplied to the consumption measuring device, and an outlet connection at which the gaseous medium is provided by the consumption measuring device, wherein a gas path is provided between the inlet connection and the outlet connection, in which a consumption sensor is arranged, and before the consumption sensor a conditioning unit for the temperature control of the gaseous medium is arranged, and between the conditioning unit and the consumption sensor a pressure control unit is arranged, in which the gaseous medium is expanded, wherein the conditioning unit is provided with a base body, in which a medium line with a gaseous medium flowing therein is arranged, and with a buffer storage for storing heat, wherein between the base body and the buffer storage a temperature control unit is arranged, and a control unit is provided, which controls the conditioning unit, in order to maintain a predetermined setpoint temperature (Tₛₒₗₗ) of the gaseous medium.

39. The consumption measuring device according to claim 38, wherein a cooling device is arranged in the buffer storage.

40. The consumption measuring device according to claim 38, wherein a further pressure control unit is provided after the consumption sensor.

41. The consumption measuring device according to claim 38, wherein the consumption sensor is composed of a plurality of Coriolis sensors with different measurement ranges.

42. The consumption measuring device according to claim 38, wherein in the gas path after the consumption sensor a zero-adjustment valve is arranged, by which the gas path can be closed.

43. The consumption measuring device according to claim 38, wherein in the consumption measuring device an inert gas purging is provided, by which the gas path can be purged with inert gas.

44. A consumption measuring device, comprising a control unit for controlling a conditioning unit having a base body and a buffer storage,
wherein a medium is supplied through the base body and a temperature control unit having a first heating surface and a second heating surface is arranged between the buffer storage and the base body, and wherein a temperature spread is set between the first heating surface and the second heating surface by means of the temperature control unit,
wherein the conditioning unit is controlled in order to maintain a predetermined setpoint temperature (Tₛₒₗₗ) of the medium,
wherein a control variable (Y) for the control of the conditioning unit is composed of a model part (A), which calculates the power (Pᵥ) required for the temperature control of the medium in the conditioning unit, and a control part (R), which corrects the power (Pᵥ) calculated by means of the model part (A),
wherein a control error (F) based on the setpoint temperature (Tₛₒₗₗ) and an actual temperature (Tᵢₛₜ) is introduced in an exponential form into the control part (R).
